(19) United States
(12) Patent Application Publication
(10) Pub. No.: US 2014/0284397 A1
(43) Pub. Date: Sep. 25, 2014

(54) SYNTHETIC JET EJECTOR EQUIPPED WITH COLD TEMPERATURE START CONTROL DELAY

(71) Applicant: NUVENTIX, INC., Austin, TX (US)

(72) Inventor: John Stanley Booth, Austin, TX (US)

(73) Assignee: NUVENTIX, INC., Austin, TX (US)

(21) Appl. No.: 14/211,836

(22) Filed: Mar. 14, 2014

Related U.S. Application Data
(60) Provisional application No. 61/789,757, filed on Mar. 15, 2013.
(60) Provisional application No. 61/793,137, filed on Mar. 15, 2013.
(60) Provisional application No. 61/793,720, filed on Mar. 15, 2013.

(51) Int. Cl. B05B 12/02

(52) U.S. Cl. CPC B05B 12/02
USPC 239/75

(57) ABSTRACT

A device (201) is provided which includes a host device (203) having a heat source (205) therein. A synthetic jet ejector (207) is embedded in the host device and is equipped with a temperature sensor (205) and a controller (211) which controls the operation of the synthetic jet ejector. The controller starts the synthetic jet ejector only when the temperature sensed by the temperature sensor exceeds a minimum threshold value Tᵥ.

### CROSS-REFERENCE TO RELATED APPLICATIONS

This application claims the benefit of U.S. Provisional Application No. 61789,757, filed Mar. 15, 2013, having the same title, and having the same inventor, and which is incorporated herein by reference in its entirety; and also claims the benefit of U.S. Provisional Application No. 61793,137, filed Mar. 15, 2013, entitled “SYNTHETIC JET EJECTOR EQUIPPED WITH CONTROLLER TO MATCH OPERATING LEVEL TO THERMAL REQUIREMENT”, and which is incorporated herein by reference in its entirety; and also claims the benefit of U.S. Provisional Application No. 61793,720, filed Mar. 15, 2013, entitled “SYSTEM AND METHOD FOR CONTROLLING SYNTHETIC JET EJECTOR POWER DEMAND IN DIMMING APPLICATIONS”, and which is incorporated herein by reference in its entirety.

### FIELD OF THE DISCLOSURE

The present disclosure relates generally to synthetic jet ejectors, and more particularly to motors for synthetic jet actuators that are equipped with a means for profiling magnetic flux.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System“; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of a particular, non-limiting embodiment of a device in accordance with the teachings herein which includes synthetic jet ejector which is embedded in a host device and which is equipped with a temperature sensor and controller.

### SUMMARY OF THE DISCLOSURE

In one aspect, a device is provided which comprises (a) a host device; (b) a synthetic jet ejector embedded in the host device; (c) a temperature sensor; and (d) a controller which controls the operation of the synthetic jet ejector; wherein the controller starts the synthetic jet ejector only when the temperature sensed by the temperature sensor exceeds a minimum threshold value Tᵥ.

### DETAILED DESCRIPTION

Despite the many advances in synthetic jet ejector technology, a need for further advances in this technology still exists. For example, in some extreme cold temperature applications (e.g., −50° C.) which are encountered in some military, automotive, and outdoor applications, the components of a synthetic jet ejector may experience a much higher level of stress when starting very cold as compared to when the synthetic jet ejector operates in a range of 0° C. to 50° C. This excess level of stress may reduce the lifetime of the synthetic jet ejector, or may cause an immediate failure, such as a crack or tear in the normally flexible material of the diaphragm.

It has now been found that the foregoing issue may be overcome through the provision of a controller which operates in conjunction with a temperature sensor such that the synthetic jet ejector only turns on when the temperature sensed by the temperature sensor exceeds a predetermined threshold value. Advantageously, the thermal management provided by the synthetic jet ejector is typically only needed when the sensed temperatures exceed such threshold values. Hence, preventing the synthetic jet ejector from running until such temperatures are encountered not only overcomes the aforementioned problems, but reduces energy consumption by the host device as well.

Prior to further describing the systems and methodologies disclosed herein, a brief overview of synthetic jet actuators may be helpful.

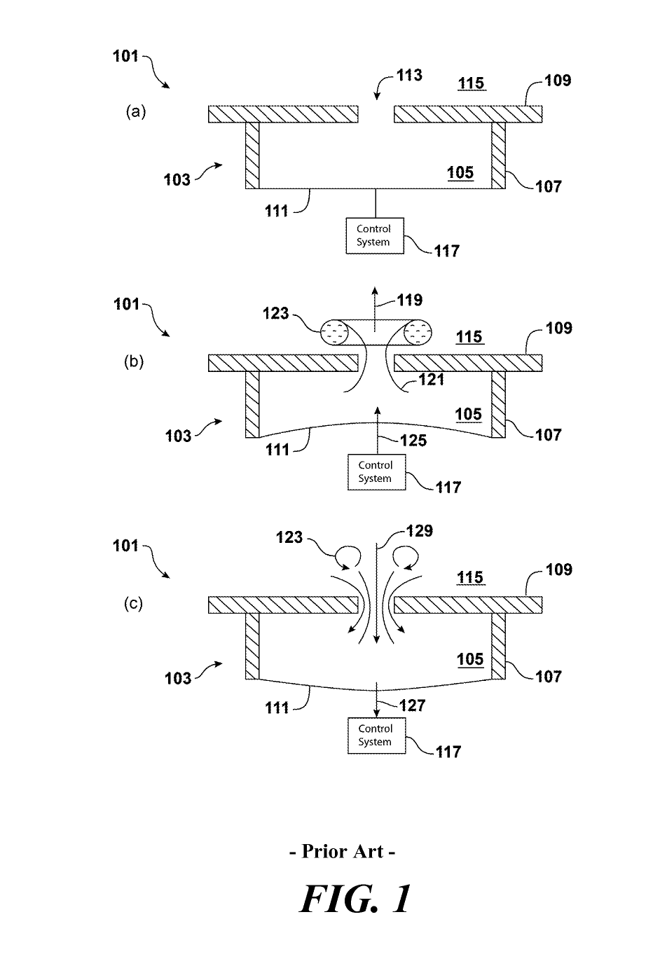

The structure of a synthetic jet ejector may be appreciated with respect to FIG. 1a. The synthetic jet ejector 101 depicted therein comprises a housing 103 which defines and encloses an internal chamber 105. The housing 103 and chamber 105 may take virtually any geometric configuration, but for purposes of discussion and understanding, the housing 103 is shown in cross-section in FIG. 1a to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be controlled by any suitable control system 117. For example, the diaphragm may be moved by a voice coil actuator. The diaphragm 111 may also be equipped with a metal layer, and a metal electrode may be disposed adjacent to, but spaced from, the metal layer so that the diaphragm 111 can be moved via an electrical bias imposed between the electrode and the metal layer. Moreover, the generation of the electrical bias can be controlled by any suitable device, for example but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 may be appreciated with respect to FIGS. 1b-FIG. 1c. FIG. 1b depicts the synthetic jet ejector 101 as the diaphragm 111 is controlled to move inward into the chamber 105, as depicted by arrow 125. The chamber 105 has its volume decreased and fluid is ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The chamber 105 has its volume increased and ambient fluid 115 rushes into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

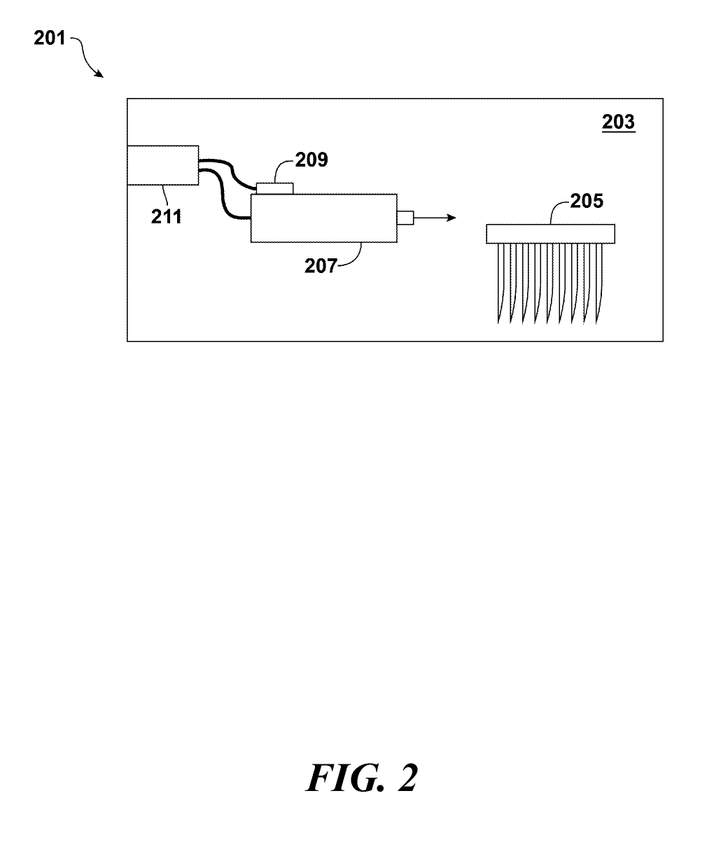

FIG. 2 is a particular, non-limiting embodiment of a device in accordance with the teachings herein. As seen therein, the device 201 features a host device 203 which includes a heat source 205 and is equipped with a combination of a synthetic jet ejector 207 and a temperature sensing element 209. A controller 211 is in electrical communication with the temperature sensing element 209, and uses the sensed temperature to determine whether the synthetic jet ejector 207 should be turned on or activated.

In a preferred embodiment, the temperature of the synthetic jet ejector 207 or its environment is sensed when the host device 203 is switched on or powered up. If the detected temperature is below a preset threshold, then the synthetic jet ejector 207 does not begin mechanical motion of the diaphragm mechanism. As the heat source 205 raises the temperature of the synthetic jet ejector 207 and/or a component thereof (e.g., its heat sink) above a predetermined threshold value, the synthetic jet ejector 207 will begin mechanical motion. In some embodiments, the amplitude of the motion of the diaphragm in the synthetic jet ejector 203 and/or its frequency may change as a function of the sensed temperature (e.g., it may be ramped up with temperature increase). In other embodiments, the synthetic jet ejector 207 merely enters an active state when the temperature threshold is exceeded, and enters an inactive state when the temperature threshold has not been exceeded or when the host device has been powered off or has entered a sleep state, hibernation state, or power saving state.

In some embodiments, one or more sensors may be placed on the synthetic jet ejector and/or on an associated heat sink to implement this temperature sensing. Preferably, however, the cooling requirement below the threshold value required for activation of the synthetic jet ejector is minimal, so that there will typically be no thermal risk to the cooled equipment by the delayed start of the synthetic jet ejector. Of course, above the threshold value, the synthetic jet ejector may be utilized to provide any required thermal management. Advantageously, the foregoing approach may allow the synthetic jet ejector to retain its high reliability by avoiding or minimizing overstress conditions.

Based on user specifications and requirements, temperature sensors which are used to control activation of the synthetic jet ejector may be placed as required on the synthetic jet ejector, an associated heat sink, or in the host device or components thereof. The synthetic jet ejector controller or optional electronics may sense these temperatures, compare them to any programmed or predetermined threshold value, and then activate the synthetic jet ejector cooling at the required level when the threshold value has been met or exceeded.

As a particular example of an application for a device of the type disclosed herein, LED headlights for automotive applications may experience low temperature extremes and may then be required to turn on immediately. However, there will typically be a time delay before the temperature of the associated hardware rises and the LEDs require active cooling by the synthetic jet ejector. The components of the synthetic jet ejector will have warmed by that point. Hence, by delaying the operation of the synthetic jet ejector until such time as it is needed (e.g., because a predetermined temperature threshold for the synthetic jet ejector or the host device has been exceeded), overstress conditions may be avoided or minimized, thus maintaining high reliability in the synthetic jet ejector.

Other applications for the devices and methodologies disclosed herein include their use in computational devices. These include, without limitations, desktop computers, laptop computers, and handheld devices such as, for example, smart phones or personal digital assistants.

The threshold temperature utilized in the devices and methodologies disclosed herein may vary from one application to another. However, in many applications, the threshold temperature may be set at a temperature within the range of 0° C. to 50° C.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A device, comprising:
a host device;
a synthetic jet ejector embedded in said host device;
a temperature sensor; and
a controller which controls the operation of the synthetic jet ejector, and which is in communication with said temperature sensor;
wherein the controller starts the synthetic jet ejector only when the temperature sensed by the temperature sensor exceeds a minimum threshold value Tᵥ.

2. The device of claim 1, wherein Tᵥ≧0° C.

3. The device of claim 1, wherein 0° C.≦Tᵥ≦50° C.

4. The device of claim 1, wherein said temperature sensor is mounted on said synthetic jet ejector.

5. The device of claim 1, wherein the controller starts the synthetic jet ejector when the host device is powered up if Tᵥ≧0° C.

6. The device of claim 1, wherein the host device is an LED fixture.

7. The device of claim 6, wherein the LED fixture is a vehicle headlight.

8. The device of claim 1, wherein the host device is a computational device.

9. The device of claim 8, wherein the host device is a handheld device.

10. The device of claim 8, wherein the host device is a desktop PC or a laptop PC.
